(19) United States
(12) Patent Application Publication
(10) Pub. No.: US 2021/0201420 A1
(43) Pub. Date: Jul. 1, 2021

(54) INFORMATION PROCESSING APPARATUS, INFORMATION PROCESSING METHOD, AND NON-TRANSITORY STORAGE MEDIUM

(71) Applicant: Toyota Jidosha Kabushiki Kaisha, Toyota-shi Aichi-ken (JP)

(72) Inventor: Daiki Kaneichi, Tokyo-to (JP)

(21) Appl. No.: 17/130,361

(22) Filed: Dec. 22, 2020

(30) Foreign Application Priority Data
Dec. 26, 2019 (JP) 2019-235667

(51) Int. Cl. G06Q 40/08; G06Q 30/02; G07C 5/08

(52) U.S. Cl. CPC G06Q 40/08; G07C 5/0841; G06Q 30/0283

(57) ABSTRACT

An information processing apparatus includes a control unit configured to calculate an insurance premium of insurance for a vehicle, based on at least a time length of travel of the vehicle on a public road and a time length of travel of the vehicle on other than the public road, or a travel distance of the vehicle on the public road and a travel distance of the vehicle on other than the public road.

### CROSS REFERENCE TO RELATED APPLICATION

This application claims the benefit of Japanese Patent Application No. 2019-235667, filed on Dec. 26, 2019, which is hereby incorporated by reference herein in its entirety.

### BACKGROUND

### Technical Field

The present disclosure relates to an information processing apparatus, an information processing method, and a non-transitory storage medium.

### Description of the Related Art

There is disclosed a technique of calculating an insurance premium according to a region on the basis of a cumulative value obtained by adding up weights assigned to respective divided regions in a region where a user's activities take place (for example, Patent document 1). The insurance premium is thus calculated on the basis of a route of activities of a user.

Now, in relation to delivery, use of a small vehicle for last one mile delivery or delivery inside a building of a commercial facility or the like is being considered, for example.

### CITATION LIST

### [Patent Document]

### [Patent Document 1]

Japanese Patent Laid-Open No. 2003-178190

### SUMMARY

A surrounding environment of a small vehicle differs between a case where the small vehicle travels on a public road and a case where the small vehicle travels in a location other than the public road, such as inside a building, and the scale of accident that may occur, property that may be damaged and the like are also different. However, currently, although property insurance assuming a vehicle traveling on a public road exists, there is no property insurance that assumes a vehicle traveling in locations other than a public road. Currently, only some types of existing property insurance cover property damage occurring on a private property such as a parking lot, as a location other than a public road, for example.

One aspect of the disclosure is aimed at providing an information processing apparatus, an information processing method, and a non-transitory storage medium capable of calculating an insurance premium for a vehicle that can travel on other than a public road.

One aspect of the present disclosure is an information processing apparatus including a control unit configured to calculate an insurance premium of insurance for a vehicle, based on at least a time length of travel of the vehicle on a public road and a time length of travel of the vehicle on other than the public road, or a travel distance of the vehicle on the public road and a travel distance of the vehicle on other than the public road.

Another aspect of the present disclosure is an information processing method performed by a computer, the computer configured to calculate an insurance premium of insurance for a vehicle, based on at least a time length of travel of the vehicle on a public road and a time length of travel of the vehicle on other than the public road, or a travel distance of the vehicle on the public road and a travel distance of the vehicle on other than the public road.

An aspect of the present disclosure is a non-transitory storage medium storing a program for causing a computer to calculate an insurance premium of insurance for a vehicle, based on at least a time length of travel of the vehicle on a public road and a time length of travel of the vehicle on other than the public road, or a travel distance of the vehicle on the public road and a travel distance of the vehicle on other than the public road.

With the information processing apparatus, the information processing method, and the non-transitory storage medium of the disclosure, an insurance premium may be calculated for a vehicle that travels on other than a public road.

### BRIEF DESCRIPTION OF THE DRAWINGS

FIG. 1 is a diagram illustrating an example of a system configuration of an insurance premium calculation system according to a first embodiment;

FIG. 2 is a diagram illustrating an example of a hardware configuration of an insurance management server;

FIG. 3 is a diagram illustrating an example of a hardware configuration of a vehicle;

FIG. 4 is a diagram illustrating examples of functional configurations of the insurance management server, the vehicle, and a delivery management server;

FIG. 5 is an example of travel record information;

FIG. 6 is an example of an insurance information management table;

FIG. 7 is an example of an analysis result of the travel record information;

FIG. 8 is an example of a contract information management table;

FIG. 9 is an example of a flowchart of a calculation process for an insurance premium;

FIG. 10 is an example of a flowchart of a calculation process for an insurance payout amount; and

FIG. 11 is an example of an insurance information management table according to a second embodiment.

### DESCRIPTION OF THE EMBODIMENTS

An expected scale of accident, an expected property to be damaged, and the like are different for an accident occurring on a public road, and for an accident occurring on other than a public road. For example, in a case where a small, autonomous driving vehicle for performing last one mile delivery is assumed, accidents that occur specifically on public roads include collisions with passenger cars, motorcycles and the like, and collisions with installed objects such as utility poles, guardrails and the like. On the other hand, in a case where the small, autonomous driving vehicle travels inside a commercial facility, which is an example of a location other than public roads, accidents that occur specifically in the commercial facility include collisions with showcases, accidents involving stairs, elevators and escalators, and the like. Therefore, desired coverage is different between a case where a vehicle travels on public roads and a case where a vehicle travels on other than public roads.

One aspect of the present disclosure is an information processing apparatus including a control unit configured to calculate an insurance premium of insurance for a vehicle, based on at least a time length of travel of the vehicle on a public road and a time length of travel of the vehicle on other than the public road, or a travel distance of the vehicle on the public road and a travel distance of the vehicle on other than the public road. For example, the information processing apparatus is a server, a personal computer (PC), a smartphone, a tablet terminal or the like.

The vehicle according to one aspect of the present disclosure is a small vehicle, for example. The small vehicle is a vehicle for delivering packages, a vehicle for transporting people, or a vehicle that cruises through without carrying people or cargos, for example. The small vehicle may be an autonomous driving vehicle that is capable of unmanned traveling, or may be a vehicle that travels by being operated by a person, for example. According to one aspect of the present disclosure, the insurance premium may be calculated for a vehicle that is capable of traveling also on other than public roads. Furthermore, the insurance premium is a sum that is according to at least the time length of traveling on a public road and the time length of traveling on other than the public road, or the travel distance of the vehicle on the public road and the travel distance of the vehicle on other than the public road, and thus, distribution characteristics of locations where the vehicle travels are reflected in the sum. That is, the insurance premium may be calculated to be higher for a vehicle for which the time length of traveling on other than public roads is longer, for example.

Next, locations other than public roads may include various types of locations such as a commercial facility, an apartment building, a building, a plant and the like, and expected accidents, property to be damaged and the like are different for respective types. It is not customary to purchase, for one vehicle, a plurality of types of insurance corresponding to respective travel locations, such as for public roads and for other than public roads or for each type of building, and also, purchasing insurance for each travel location is burdensome for a person purchasing insurance. Accordingly, in the present disclosure, application of a plurality of types of insurance corresponding to respective travel locations by one contract is enabled, for example.

Specifically, according to one aspect of the present disclosure, the control unit may be configured to determine a weight of each of a plurality of types of insurance with different coverage details, based on at least the time length of travel of the vehicle on the public road and the time length of travel of the vehicle in locations other than the public road, that is, respective locations corresponding to a plurality of types of locations including inside a building, or the travel distance of the vehicle on the public road and the travel distance of the vehicle in respective locations corresponding to the plurality of types of locations, and may be configured to calculate an insurance premium of one contract for the vehicle, based on the weight of each of the plurality of types of insurance. The types of locations include a commercial facility, an apartment building, a building, a plant and the like, for example. Furthermore, granularity of the types of locations may be arbitrarily set, such as on a per-building basis.

Furthermore, according to one aspect of the present disclosure, the vehicle may be able to travel also on public roads. The control unit may be configured to determine the weight of each of the plurality of types of insurance with different coverage details, based on the time lengths when the vehicle is traveling in respective locations corresponding to a plurality of types of locations at least including two types of the public road and other than the public road, and may be configured to calculate an insurance premium of one contract for the vehicle, based on the weight of each of the plurality of types of insurance.

For example, the plurality of types of insurance may include types of insurance corresponding to different types of locations among a plurality of types of locations at least including the public road and other than the public road. Specifically, the plurality of types of insurance include insurance whose coverage details are set with the public road as the travel location, and insurance whose coverage details are set with locations other than the public road, a predetermined type of location, or a predetermined building as the travel location. That is, in this case, each of the plurality of types of insurance is insurance comprehensively including basic contracts covering vehicles, third-party injury, third-party property and the like, the insurance being set according to a target travel location.

Alternatively, the plurality of types of insurance may be types of insurance with different objects of coverage among a plurality of objects of coverage, for example. In this case, the plurality of types of insurance are automobile physical damage insurance, third-party property insurance, third-party injury insurance, cargo insurance, and first-party injury insurance, for example.

According to one aspect of the present disclosure, a plurality of types of insurance corresponding to locations where the vehicle possibly travels may be purchased as one contract for the vehicle that is capable of traveling on public roads and on other than the public roads. This eliminates the need to purchase a plurality of contracts, and the burden on a policyholder may thus be reduced. Furthermore, the insurance premium in this case is calculated according to a travel time length in each of the types of locations where the vehicle is to travel, and thus, the sum takes into account the distribution characteristics of locations where the target vehicle travels. Accordingly, it is possible to give the policyholder of the insurance the impression that the insurance premium is appropriate or cheap, for example.

Furthermore, according to one aspect of the present disclosure, the control unit may be configured to determine the weight of each of the plurality of types of insurance, based further on a time length of each of a plurality of loading states of the vehicle, the plurality of loading states including a state where an occupant or a cargo is on board and a state where an occupant or a cargo is not on board. In a case where the vehicle is used for delivery, the loading states may be a state where an occupant or a package is on board and a state where an occupant or a package is not on board, for example. In a state when an occupant or a package is on board, the occupant is possibly injured or the package is possibly damaged by an accident. Accordingly, it is desirable that coverage details change depending on the loading state. In a case where the coverage details change depending on the loading state, because risks change depending on the time length of the state where an occupant or a package is on board the vehicle, the insurance premium is desirably also changed depending on the time lengths of the respective loading states of the vehicle. By determining the weights of the plurality of types of insurance also on the basis of the time lengths of the respective loading states of the vehicle, the insurance premium may be such that the level of the state where a person or a cargo is on board the vehicle is taken into account.

Furthermore, according to one aspect of the present disclosure, the control unit may be configured to calculate, as the insurance premium for the vehicle, a total value obtained by multiplying a basic insurance premium of each of the plurality of types of insurance by a corresponding weight. An insurance premium according to the time length when the vehicle travels in a location corresponding to each of the types of locations may thus be calculated.

Furthermore, according to one aspect of the present disclosure, the control unit may be configured to acquire, from travel record information on the vehicle for a predetermined period of time in immediate past, at least the time length of travel of the vehicle on the public road and the time length of travel of the vehicle on other than the public road, or the travel distance of the vehicle on the public road and the travel distance of the vehicle on other than the public road. In this case, the predetermined period of time in the immediate past may be taken as a coverage period of the insurance premium that is calculated. Normally, car insurance adopts a so-called advance payment method, according to which an insurance premium that takes a predetermined period of time in future as the coverage period is determined on the basis of an expected value of annual travel distance, a past accident record or the like. According to one aspect of the present disclosure, a so-called future payment method is adopted, according to which the insurance premium for the predetermined period of time in the immediate past is calculated on the basis of traveling performance of the vehicle in the predetermined period of time in the immediate past, and thus, the insurance premium may be in better accordance with the traveling performance of the vehicle. Accordingly, payment of insurance premium for unnecessary coverage details may be suppressed, for example.

Furthermore, according to one aspect of the present disclosure, the control unit may be further configured to specify, in a case where there is occurrence of an accident involving the vehicle, according to a location of occurrence of the accident, insurance that is to be applied from among the plurality of types of insurance, and to calculate an insurance payout amount to be paid to compensate for a damage caused by the accident, according to the insurance that is specified. Switching between types of insurance to be applied is thus performed according to the travel location of the vehicle, and compensation according to the location of occurrence of the accident may be received.

Furthermore, according to one aspect of the present disclosure, the control unit may be configured to specify the insurance that is to be applied, based further on a loading state of the vehicle at a time of occurrence of the accident. Switching between types of insurance to be applied is thus performed according to whether an occupant or a package is on board the vehicle or not, or according to the number of occupants or the number of packages on board, for example, and compensation according to the state at the time of occurrence of the accident may be received.

Hereinafter, embodiments of the present disclosure will be described with reference to the drawings. Configurations of the embodiments below are merely examples, and the present disclosure is not limited to the configurations of the embodiments.

### First Embodiment

<System Overview>

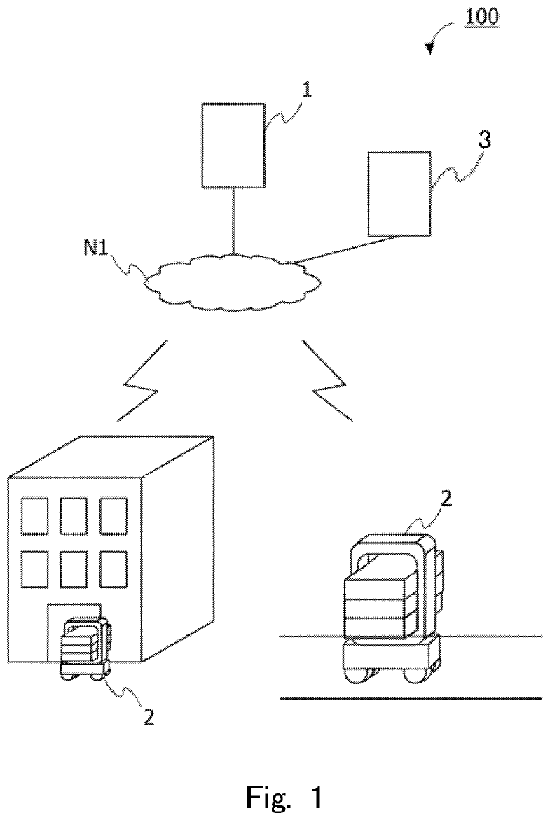

FIG. 1 is a diagram illustrating an example of a system configuration of an insurance premium calculation system 100 according to a first embodiment. The insurance premium calculation system 100 is a system for calculating an insurance premium of insurance for a vehicle that is capable of traveling on public roads and on other than public roads, the insurance covering both public roads and other than public roads, for example. The insurance premium calculation system 100 includes an insurance management server 1, a vehicle 2, and a delivery management server 3. The insurance management server 1, the vehicle 2, and the delivery management server 3 are each connected to a network N1. For example, the network N1 is the Internet.

For example, the vehicle 2 is a small electric vehicle that is capable of autonomous driving and unmanned driving. In the first embodiment, the vehicle 2 is assumed to be a small vehicle that performs last one mile delivery of packages. Specifically, the vehicle 2 is in charge of delivery in one of a section between a delivery center and a delivery destination, a section between an arterial road and a delivery destination, and a section between front of a building and a delivery destination inside the building, for example. Alternatively, the vehicle 2 may be a vehicle that performs delivery of packages inside a building. The vehicle 2 communicates with the delivery management server 3 over the network N1. For example, the vehicle 2 performs 3rd generation (3G), long term evolution (LTE), LTE-Advanced or 5th generation (5G) mobile communication, or wireless communication according to wireless LAN standard such as WiFi. Additionally, the insurance premium calculation system 100 may include a plurality of vehicles 2, but FIG. 1 illustrates only one vehicle 2 for the sake of convenience.

When an operation command is received from the delivery management server 3, the vehicle 2 creates an operation plan, and performs autonomous driving to a destination according to the operation plan. The vehicle 2 includes an acquisition unit for position information, and acquires position information and the like every predetermined period of time, and transmits the position information and the like to the delivery management server 3.

For example, the delivery management server 3 is a server that is managed by a delivery company, and that manages deliveries on a per-area basis. For example, a delivery center is established in each area. Packages to be delivered are first collected at the delivery center in a delivery source area, and are then transported to a delivery center in a delivery destination area and delivered to delivery destinations from the delivery center in the delivery destination area, for example. In the first embodiment, the vehicle 2 is in charge of deliveries within an area.

The delivery management server 3 creates a delivery plan inside an area and determines the vehicle 2 that is to perform delivery of each package. The delivery plan includes collection location and time of a package, and delivery destination and time slot of the package, for example. In a case where the vehicle 2 is to be transported by another large vehicle to a point near the delivery destination, for example, the delivery plan also includes information about the vehicle which the vehicle 2 is to get on board, a boarding point, a drop-off point, and the like. The delivery plan is transmitted from the delivery management server 3 to the vehicle 2, and the vehicle 2 creates an operation plan and performs delivery according to the delivery plan.

The delivery management server 3 receives the position information from the vehicle 2 every predetermined period of time and holds travel record information on the vehicle 2. For example, in addition to the position information, information such as speed information, the loading state of a package, and an occurred event may be received from the vehicle 2. Events that are detected by the vehicle 2 include entry into a building, exit from a building, and delivery completion of a package, for example. Occurrence of these events may be detected on the basis of operations at the time of entry of the vehicle 2 into a building, at the time of exit from a building, and at the time of delivery completion of a package, for example. Operations at the time of entry of the vehicle 2 into a building and exit from a building are detected on the basis of an unlocking operation by near field communication (NFC) or communication with a device installed at a gate, for example. Delivery completion of a package may be detected by an operation on the vehicle 2 by a recipient, for example.

The insurance management server 1 calculates an insurance premium for the vehicle 2 that is capable of traveling on both public roads and other than public roads. In the first embodiment, the insurance premium is calculated for a plurality of types of insurance that are combined as one contract, the plurality of types of insurance including insurance that covers traveling on public roads, and insurance that covers traveling on other than public roads, such as inside a predetermined building or facility, for example. Additionally, the insurance premium is the money paid by a policyholder, and an insurance payout is the money paid to the policyholder.

For example, the insurance management server 1 acquires, from the delivery management server 3, the travel record information on the vehicle 2 for a predetermined period of time in the immediate past, and analyzes what kind of location the vehicle 2 traveled and to what extent. The insurance management server 1 calculates the insurance premium of one contract combining a plurality of types of insurance for the predetermined period of time, on the basis of what kind of location the vehicle 2 traveled and to what extent. Travel locations of the vehicle 2 are categorized into a plurality of types, for example. Types of locations include a public road, a building, a facility, and a parking lot, for example. Information indicating extent of travel of the vehicle 2 includes a travel time length in each type of location, a travel distance and the like. The predetermined period of time in relation to which the travel record information is acquired is one month, several months, or one year from a predetermined start date to an end date, for example. More specifically, one month from the first day to the last day of a month, or one month from the tenth of a month to the ninth of the next month is set, for example.

According to the first embodiment, the insurance premium for a predetermined period of time is calculated on the basis of a travel record for the predetermined period of time, and the insurance premium may thus be based on an actual travel state of the vehicle 2. Because a plurality of types of insurance corresponding to the types of locations are purchased as one contract, switching between types of insurance to be applied is performed according to the travel location of the vehicle 2.

Furthermore, in a case where there is occurrence of an accident involving the vehicle 2 and the policyholder claims insurance payout, the insurance management server 1 specifies, from the travel record information on the vehicle 2, the insurance to be applied to the location of occurrence of the accident, and calculates the insurance payout amount to be paid according to stipulations of the specified insurance, for example. An insurance payout amount according to an accident that is expected at the travel location of the vehicle 2 will thus be paid.

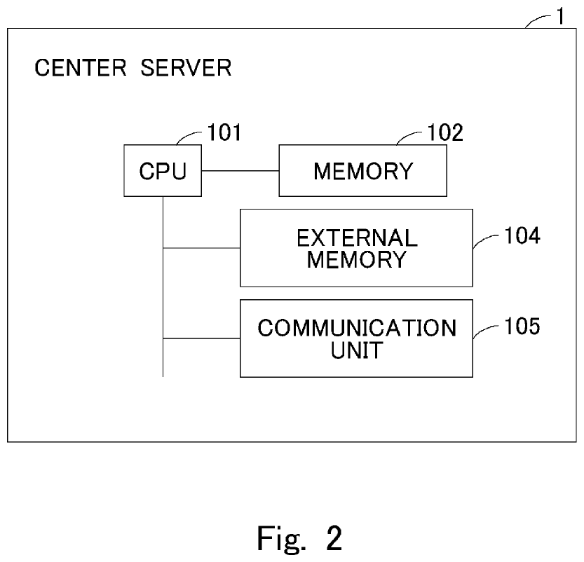

FIG. 2 is a diagram illustrating an example of a hardware configuration of the insurance management server 1. The insurance management server 1 includes a CPU 101, a memory 102, an external memory 104, and a communication unit 105. The CPU 101 executes a computer program that is loaded into the memory 102 in an executable manner and performs processing as the insurance management server 1.

The memory 102 stores computer programs to be executed by the CPU 101, data to be processed by the CPU 101, and the like. For example, the memory 102 is a dynamic random access memory (DRAM), a static random access memory (SRAM) and/or a read only memory (ROM). The external memory 104 is a non-volatile memory device and is a solid state drive (SSD) and/or a hard disk drive, for example.

The communication unit 105 is connected to a public communications network through a LAN, and communicates with various servers on the network N1, the vehicle 2, the delivery management server 3 and the like through the public communications network, for example. Additionally, the hardware configuration of the insurance management server 1 is not limited to the one illustrated in FIG. 2, and addition or replacement may be performed as appropriate according to the embodiment.

Additionally, the delivery management server 3 includes a CPU, a memory, an external memory, and a communication unit as those of the insurance management server 1, but illustration thereof is omitted.

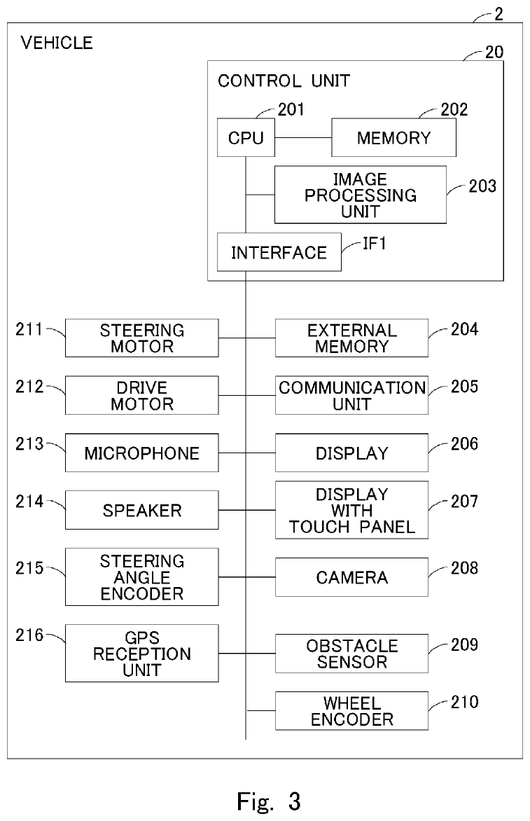

FIG. 3 is a diagram illustrating an example of a hardware configuration of the vehicle 2. In FIG. 3, the vehicle 2 is described to be an electric vehicle that is capable of autonomous driving. Additionally, in FIG. 3, hardware related to a control system is extracted and illustrated.

The vehicle 2 includes a control unit 20, an external memory 204, a communication unit 205, a display 206, a display 207 with a touch panel, a camera 208, an obstacle sensor 209, a wheel encoder 210, a steering motor 211, a drive motor 212, a microphone 213, a speaker 214, a steering angle encoder 215, and a global positioning system (GPS) reception unit 216.

The control unit 20 is referred to also as an electronic control unit (ECU). The control unit 20 includes a CPU 201, a memory 202, an image processing unit 203, and an interface IF1. The external memory 204, the communication unit 205, the display 206, the display 207 with a touch panel, the camera 208, the obstacle sensor 209, the wheel encoder 210, the steering motor 211, the drive motor 212, the microphone 213, the speaker 214, the steering angle encoder 215, and the GPS reception unit 216 are connected to the interface IF1.

The obstacle sensor 209 is an ultrasonic sensor, a radar or the like. The obstacle sensor 209 transmits ultrasonic waves, electromagnetic waves or the like in a detection target direction, and detects, on the basis of reflected waves, presence, position, relative speed and the like of an obstacle in the detection target direction. Obstacles include pedestrians, bicycles, structures, buildings and the like, for example. The vehicle 2 is provided with a plurality of obstacle sensors 209, and the plurality of obstacle sensors 209 are each provided at positions near four front, back, left and right corner portions of the vehicle 2, for example. Additionally, the front, back, left and right of the vehicle 2 are determined on the basis of a traveling direction, for example.

The camera 208 is a capturing device that uses an image sensor such as a charge-coupled device (CCD), a metal-oxide-semiconductor (MOS), a complementary metal-oxide-semiconductor (CMOS) or the like. The camera 208 acquires an image every predetermined period of time called frame period and stores the image in a frame buffer in the control unit 20. The vehicle 2 is provided with a plurality of cameras 208, and the plurality of cameras 208 are each installed in a manner facing outside the vehicle and in different directions. However, such a case is not restrictive, and the cameras 208 may include one that is installed facing inside the vehicle.

The steering motor 211 controls, according to an instruction signal from the control unit 20, an angle of a direction of an intersecting line along which a rotating surface of a wheel and a horizontal plane intersect, or in other words, an angle of a traveling direction of rotation of the wheel. The drive motor 212 drives and rotates each of four wheels provided on the vehicle 2, according to an instruction signal from the control unit 20, for example. Alternatively, the drive motor 212 may drive one pair of wheels among two pairs of front and rear wheels.

The steering angle encoder 215 detects a steering angle that is the traveling direction of a wheel at predetermined detection time intervals and stores the steering angle in a register of the control unit 20. The steering angle is an angle of a rotation axis of the wheel on the horizontal plane. For example, an origin of the angle is set at which a direction of the rotation axis of the wheel is perpendicular to the traveling direction of the vehicle 2. Furthermore, the wheel encoder 210 acquires a rotation angle of the wheel at predetermined detection time intervals and stores the rotation angle in the register of the control unit 20.

The communication unit 205 is a communication unit that connects to a WiFi access point or a mobile phone base station, for example, and that communicates with various servers and the like on a network through a public communication network connected to the WiFi access point or the mobile phone base station. The communication unit 205 performs wireless communication using wireless signals and a wireless communication method according to a predetermined wireless communication standard.

The GPS reception unit 216 receives radio waves carrying time signals from a plurality of global positioning satellites orbiting the Earth and stores the time signals in the register of the control unit 20. The microphone 213 detects sound, converts the sound into a digital signal, and stores the digital signal in the register of the control unit 20. The speaker 214 is driven by a D/A converter and an amplifier connected to the control unit 20 or a signal processing unit and reproduces acoustics including sound and voice. The microphone 213 and the speaker 214 may include those that are provided facing the inside of the vehicle 2, and those facing the outside of the vehicle 2.

The CPU 201 of the control unit 20 executes a computer program that is loaded into the memory 202 in an executable manner and performs processing as the control unit 20. The memory 202 stores computer programs to be executed by the CPU 201, data to be processed by the CPU 201, and the like. For example, the memory 202 is a dynamic random access memory (DRAM), a static random access memory (SRAM) and/or a read only memory (ROM). The image processing unit 203 processes, in coordination with the CPU 201, data in the frame buffer that is acquired from the camera 208 every predetermined frame period. The image processing unit 203 includes a GPU and an image memory as the frame buffer, for example. The external memory 204 is a non-volatile memory and is a solid state drive (SSD) and/or a hard disk drive, for example.

For example, the control unit 20 acquires detection signals from a sensor of each unit of the vehicle 2 via the interface IF1. Furthermore, the control unit 20 calculates latitude and longitude indicating a position on the Earth, from detection signals from the GPS reception unit 216. Furthermore, the control unit 20 acquires map data from a map information database stored in the external memory 204, checks the calculated latitude and longitude against a position in the map data, and determines a current location. Moreover, the control unit 20 acquires a route from the current location to a destination in the map data. Moreover, the control unit 20 detects an obstacle in the surroundings of the vehicle 2 on the basis of signals from the obstacle sensor 209, the camera 208 and the like, and determines the traveling direction and controls the steering angle to avoid the obstacle.

Furthermore, the control unit 20 processes, in coordination with the image processing unit 203, an image acquired from the camera 208, on a per-frame data basis, detects a change on the basis of a difference between images, for example, and recognizes an obstacle. Additionally, the control unit 20 may transmit frame data of an image of the camera 208 and audio data obtained from the microphone 213, from the communication unit 205 to a server on a network. Then, analysis of the frame data of the image and the audio data may be assigned to the server.

Furthermore, the control unit 20 causes images, texts, and other pieces of information to be displayed on the display 206. Moreover, the control unit 20 is capable of detecting an operation on the display 207 with a touch panel, and of receiving an instruction from a user.

FIG. 3 illustrates the interface IF1, but exchange of signals between the control unit 20 and a control target is not limited to be performed through the interface IF1. That is, the control unit 20 may include a plurality of signal exchange paths other than the interface IF1. Furthermore, in FIG. 3, the control unit 20 includes a single CPU 201. However, the CPU is not limited to a single processor, and may have a multi-processor configuration. Alternatively, a single CPU connected by a single socket may have a multi-core configuration. At least a part of processes by each unit described above may be performed by a processor other than the CPU, such as a dedicated processor such as a digital signal processor (DSP) or a graphics processing unit (GPU). Furthermore, at least a part of processes by each unit described above may be implemented by an integrated circuit (IC) or another digital circuit. An analog circuit may be included in at least one of the units described above.

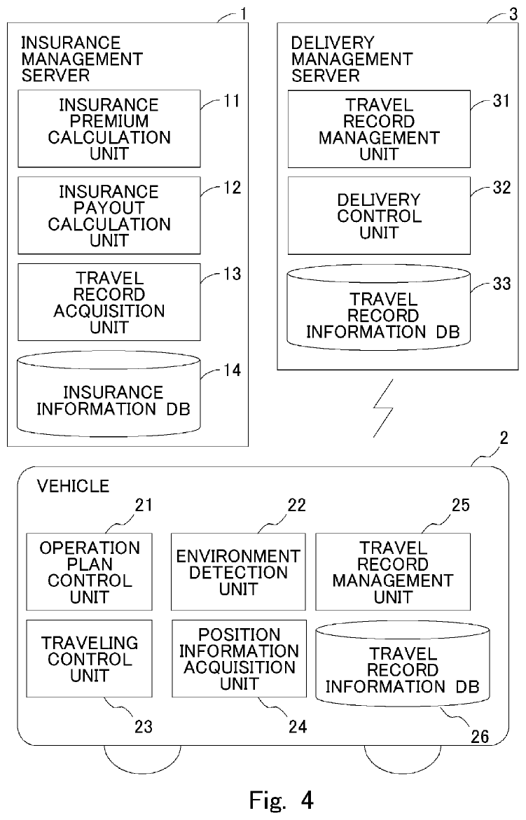

FIG. 4 is a diagram illustrating examples of functional configurations of the insurance management server 1, the vehicle 2, and the delivery management server 3. The vehicle 2 operates as each unit illustrated in FIG. 4 by computer programs in the memory 202. For example, as functional structural elements, the vehicle 2 includes an operation plan control unit 21, an environment detection unit 22, a traveling control unit 23, a position information acquisition unit 24, a travel record management unit 25, and a travel record information DB 26.

For example, the position information acquisition unit 24 acquires the position information on the vehicle 2 acquired by the GPS reception unit 216 or the like, every predetermined period of time. The position information on the vehicle 2 is latitude and longitude, for example. Alternatively, the position information on the vehicle 2 may be an address, for example. The position information on the vehicle 2 acquired by the position information acquisition unit 24 is output to the operation plan control unit 21, the traveling control unit 23, and the travel record management unit 25, for example.

The operation plan control unit 21 receives a delivery plan for the vehicle 2, from the delivery management server 3. For example, the delivery plan includes information about a package that is a delivery target, a delivery destination, a scheduled delivery time, a loading point, a scheduled loading time, a vehicle to be boarded, and boarding/drop-off points.

The operation plan control unit 21 creates an operation plan on the basis of the delivery plan. The operation plan includes data about a route on which the vehicle 2 is to travel, and data specifying processes to be performed by the vehicle 2 on a part of the route or along the entire route, for example. Examples of the processes to be performed by the vehicle 2 include processes of entry into and exit from a building that is a delivery destination, handing over of a package at the delivery destination, and the like. The operation plan control unit 21 outputs the created operation plan to the traveling control unit 23. The operation plan control unit 21 may also transmit the created operation plan to the delivery management server 3. The operation plan includes a route to a loading point of a package that is to be reached at or before the scheduled loading time, a route from the loading point of the package to the delivery destination that is to be reached by the scheduled delivery time, and an instruction for handing over of the package at the delivery destination, for example.

The environment detection unit 22 detects environment information about surroundings of the vehicle 2 to be used for autonomous traveling, on the basis of data acquired by various sensors mounted in the vehicle 2. Targets of detection of the environment detection unit 22 include, but are not limited to, the number and positions of lanes, the number and positions of vehicles present in the surroundings of a subject vehicle, the number and positions of obstacles (such as pedestrians, bicycles, structures, buildings, stairs, elevators, escalators, and shop windows) present in the surroundings of the subject vehicle, road structures, and road signs, for example. Targets of detection may be any objects so long as they are used to perform autonomous traveling. For example, in a case where the sensor is a stereo camera, object detection is performed in relation to the surroundings of the vehicle 2 by performing image processing on image data captured by the stereo camera. Data detected by the environment detection unit 22 about the surrounding environment of the vehicle 2 is output to the traveling control unit 23 described later.

For example, the traveling control unit 23 generates, on the basis of the operation plan created by the operation plan control unit 21, data about the surrounding environment of the vehicle 2 created by the environment detection unit 22, and the position information on the subject vehicle acquired by the position information acquisition unit 24, a control command for controlling autonomous traveling of the subject vehicle. For example, when an operation plan is input from the operation plan control unit 21, the traveling control unit 23 determines whether or not there is an obstacle in a movement direction indicated by the operation plan, and secures safety of movement. In a case where it is determined that there is no obstacle in the movement direction, the traveling control unit 23 generates a control command to cause the subject vehicle to travel along a route according to the operation plan. The generated control command is transmitted to the drive motor 212. A well-known method may be adopted as a method of generating the control command for causing a vehicle to perform autonomous traveling.

The travel record management unit 25 creates the travel record information on the vehicle 2 every predetermined period of time and with occurrence of a predetermined event as a trigger, and stores the created travel record information in the travel record information DB 26 and also transmits the created travel record information to the delivery management server 3. A period between creation of the travel record information is arbitrary set to 0.1 seconds to 10 seconds, for example. However, the period between creation of the travel record information is not limited thereto. Additionally, the period between creation of the travel record information and a period between creation of the position information may be the same, or the period between creation of the travel record information may be set longer. Additionally, a timing of creation of the travel record information may be set to coincide with a timing of acquisition of the position information.

Furthermore, events as the trigger for creation of the travel record information include entry into a building, exit from a building, delivery completion, and the like, for example. Occurrence of these events is detected on the basis of an operation that is performed by the vehicle 2 or an operation that is input to the vehicle 2, for example. Specifically, occurrence of events is detected on the basis of detection of passing of an entrance of a building based on transmission/reception of an unlocking or locking signal for an automatic lock by NFC or reception of a signal from a transmission device installed at the entrance, input of a delivery complete operation on an input device of the vehicle 2 by a recipient, and the like. Furthermore, at the time of transmission of the travel record information to the delivery management server 3, the travel record management unit 25 transmits identification information on the vehicle 2, together with the travel record information.

The travel record information that is created by the travel record management unit 25 includes a timestamp, position information, a speed, an event type, and the number of cargoes, for example. The position information that is included in the travel record information is the latest piece among pieces of position information input from the position information acquisition unit 24, for example. The speed is acquired from a speedometer mounted in the vehicle 2, for example. Whether the vehicle 2 is traveling or stopped at a time point of creation of the travel record information may be determined on the basis of the speed. The event type included in the travel record information may be entry into a building, exit from a building, or delivery completion of a package, for example. The number of cargoes is acquired from a detection value of a weight sensor mounted in the vehicle 2, and the delivery plan, for example.

The travel record information DB 26 is created in the external memory 204 of the vehicle 2, for example. The travel record information created by the travel record management unit 25 is stored in the travel record information DB 26.

Next, the delivery management server 3 operates as each unit illustrated in FIG. 4 by computer programs in the memory. For example, as functional structural elements, the delivery management server 3 includes a travel record management unit 31, a delivery control unit 32, and a travel record information DB 33.

The travel record management unit 31 manages the travel record information on the vehicle 2. Specifically, the travel record management unit 31 receives the travel record information that is transmitted from the vehicle 2 every predetermined period of time or at the time of occurrence of a predetermined event, and stores the travel record information in the travel record information DB 33. Furthermore, the travel record management unit 31 reads a travel record of a specified vehicle 2 for a specified period of time from the travel record information DB 33, and provides the travel record, in response to an acquisition request from the insurance management server 1.

The delivery control unit 32 manages delivery in a management target area, and creates a delivery plan for each vehicle 2. A method of generating the delivery plan is not limited to a specific method, and any well-known method may be used. For example, the delivery plan for the vehicle 2 includes collection location and time of a package, delivery destination and time slot of the package, information about a vehicle which the vehicle 2 is to get on board, a boarding point, a drop-off point, and the like. The delivery control unit 32 transmits the delivery plan to each vehicle 2.

The travel record information DB 33 stores the travel record information on each vehicle 2. For example, the travel record information DB 33 is created in a storage area of the external memory of the delivery management server 3.

Next, the insurance management server 1 operates as each unit illustrated in FIG. 4 by computer programs in the memory 102. For example, as functional structural elements, the insurance management server 1 includes an insurance premium calculation unit 11, an insurance payout calculation unit 12, a travel record acquisition unit 13, and an insurance information DB 14.

For example, the insurance premium calculation unit 11 calculates an insurance premium for the vehicle 2 every predetermined period of time or according to an input of a command from an administrator. For example, a weight of each of a plurality of types of insurance is determined according to what kind of location the vehicle 2 traveled and to what extent, and an insurance premium of one contract is calculated as the insurance premium for the vehicle 2 on the basis of the weight and the insurance premium of each type of insurance. A calculation method for the insurance premium will be described later. A period between calculation of the insurance premium is one month, six months, or one year, for example. The calculated insurance premium is output to a predetermined file, or is transmitted to another device, for example.

In the first embodiment, information about what kind of location the vehicle 2 traveled and to what extent is acquired from the travel record information for a predetermined period of time. The predetermined period of time for which the travel record information is acquired may be a specific period of time in the immediate past, for example. Furthermore, the insurance premium calculated by the insurance premium calculation unit 11 may be charged to the policyholder as the insurance premium for the predetermined period of time for which the travel record information is acquired, for example. Specifically, the insurance premium for a period of time from the first day to the last day of a previous month is charged on the basis of the travel record information for the period of time from the first day to the last day of the previous month, for example. However, such a case is not restrictive, and an insurance premium for a period of time in an immediate future may be charged on the basis of the travel record information for the specific period of time in the immediate past, for example.

The insurance payout calculation unit 12 calculates an insurance payout amount to be paid to a policyholder according to an input of a command from an administrator who received a claim for insurance payout from the policyholder, for example. Information about an accident that is a target of insurance payout is input together with the input of the command, for example. Regarding the information about an accident, information that is necessary for calculating the insurance payout amount is input, the information including identification information on a target vehicle, date/time of occurrence, a location of occurrence, damaged property, a cost of damage, and the like.

The insurance payout calculation unit 12 acquires the travel record information on the target vehicle 2 for around the time of occurrence of the accident and specifies a state of occurrence of the accident. At this time, the location of occurrence of the accident, the loading state of packages on the vehicle 2, and the like are specified, for example. The insurance payout calculation unit 12 specifies the insurance that is to be applied, according to the specified state of occurrence of the accident. For example, the insurance payout calculation unit 12 calculates the insurance payout amount that is to be paid, according to the insurance that is to be applied to the accident, damaged property, the cost of damage, and the like. The calculated insurance payout amount is output to a file, or is transmitted to another device, for example.

The travel record acquisition unit 13 acquires the travel record information on the target vehicle 2 for a specified period of time from the delivery management server 3, in response to a request from the insurance premium calculation unit 11 or the insurance payout calculation unit 12. The travel record acquisition unit 13 outputs the acquired travel record information to the insurance premium calculation unit 11 or the insurance payout calculation unit 12.

The insurance information DB 14 is created in a storage area of the external memory 104 of the insurance management server 1, for example. The insurance information DB 14 includes information about insurance, and information about contract, for example. Details of the information held in the insurance information DB 14 will be described later.

One or some of the functional structural elements of the insurance management server 1, the vehicle 2, and the delivery management server 3, or one or some of processes thereof may be implemented by another computer connected to the network. Furthermore, series of processes to be performed by the insurance management server 1, the vehicle 2, and the delivery management server 3 may be implemented by hardware or may be implemented by software.

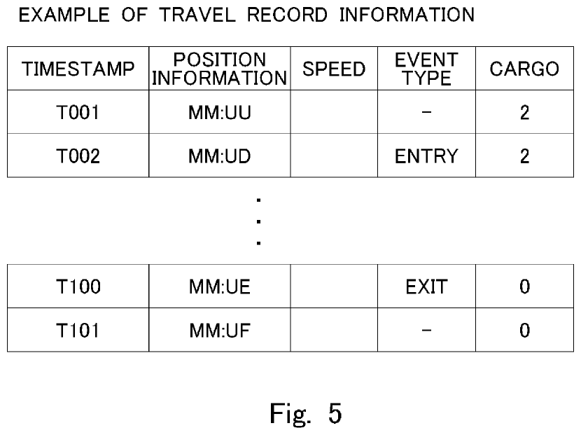

FIG. 5 is an example of the travel record information. FIG. 5 illustrates an example of the travel record information for one vehicle 2. The travel record information illustrated in FIG. 5 is the travel record information that is held in the travel record information DB 26 of the vehicle 2 and the travel record information DB 33 of the delivery management server 3.

The travel record information includes information about a timestamp, position information, a speed, an event type, and a cargo. The timestamp indicates a time when the travel record information was created. The event type is information indicating the type of an occurred event that is the trigger for creating the travel record information. The event type may be “entry”, “exit”, “loading”, or “delivery completion”, for example. The event type “entry” indicates occurrence of an event of entry into a building. The event type “exit” indicates occurrence of an event of exit from a building. The event type “loading” indicates occurrence of an event of loading of a package. The event type “delivery completion” indicates occurrence of an event of delivery completion of a package. Additionally, these events are not invariably detected.

Information about a cargo may include the number of cargoes. In a case where a cargo is loaded on the vehicle 2, the number of cargoes takes a positive integer. In a case where a cargo is not loaded on the vehicle 2, the number of cargoes is zero. The number of cargoes may be used when determining the weight of the insurance, for example.

Additionally, the travel record information illustrated in FIG. 5 is merely an example, and information to be included in the travel record information may be changed according to the embodiment, that is, according to what information is needed to calculate the insurance premium, for example.

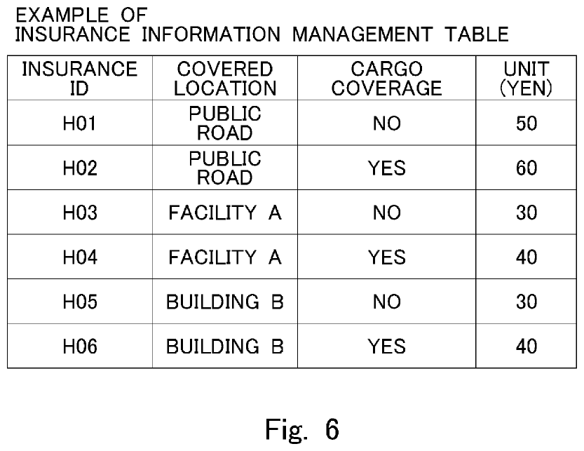

FIG. 6 is an example of an insurance information management table. The insurance information management table is a table that is held in the insurance information DB 14 of the insurance management server 1. The insurance information management table stores information about types of insurance for the vehicle 2 that can be collectively purchased as one contract.

The insurance information management table illustrated in FIG. 6 includes items of “insurance ID”, “covered location”, “cargo coverage”, and “unit”. Identification information on insurance is stored under the item “insurance ID”. Information indicating a travel location of the vehicle 2 that is covered by the insurance is stored under the item “covered location”. Locations that are covered may include public roads, predetermined facilities, and predetermined buildings, for example. Facilities, buildings and the like may be collectively treated as covered locations “other than public roads”. Information indicating whether the insurance includes compensation for a cargo or not is stored under the item “cargo coverage”. A sum that is a unit for calculating the insurance premium is stored under the item “unit”. The unit of insurance premium is an example of “basic insurance premium”.

In the example illustrated in FIG. 6, types of insurance with insurance IDs “H01”, “H02”, “H03”, “H04”, “H05”, and “H06” are set as insurance that can be collectively purchased as one contract. In the following, these types of insurance will be specified in the form of “insurance+insurance ID”.

The insurance H01 covers traveling on public roads but does not cover cargoes. The insurance H02 covers traveling on public roads and covers cargoes. The insurance H03 covers traveling inside a facility A but does not cover cargoes. The insurance H04 covers traveling inside the facility A and covers cargoes. The insurance H05 covers traveling inside a building B but does not cover cargoes. The insurance H06 covers traveling inside the building B and covers cargoes.

The covered locations and coverage details are different, and thus, the value of the unit for calculating the insurance premium is also different. The unit for calculating the insurance premium is 50 yen for the insurance H01, 60 yen for the insurance H02, 30 yen for the insurance H03, 40 yen for the insurance H04, 30 yen for the insurance H05, and 40 yen for the insurance H06. Damages are likely to be greater on public roads, and thus, the value of the unit for calculating the insurance premium tends to be greater for insurance that covers public roads. Furthermore, the value of the unit for calculating the insurance premium is greater for insurance that covers cargoes.

Additionally, the structure of the insurance information management table, the covered location of each type of insurance, the value of the unit for calculating the insurance premium, and the like illustrated in FIG. 6 are merely examples, and are not limited to those illustrated in FIG. 6.

### Example of Calculation Method for Insurance Premium

In a calculation process for the insurance premium, the insurance premium calculation unit 11 of the insurance management server 1 first acquires information indicating what kind of location the vehicle 2 travels and to what extent. In the first embodiment, the insurance premium calculation unit 11 analyzes the travel record information on the vehicle 2 for a predetermined period of time, and acquires information indicating what kind of location the vehicle 2 traveled and to what extent.

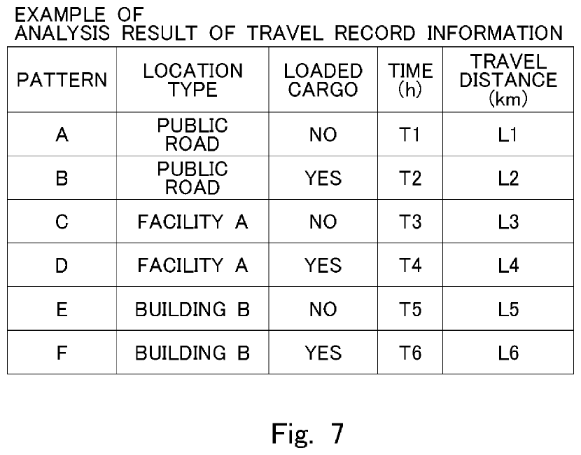

FIG. 7 is an example of an analysis result of the travel record information. In the example illustrated in FIG. 7, a travel time length and a travel distance are acquired as the analysis result of the travel record information, according to the type of the travel location and presence/absence of a loaded package, for example. That is, in the first embodiment, information indicating the extent of traveling of the vehicle 2 includes the travel time length and the travel distance. The type of the travel location is determined from the position information included in the travel record information. Presence/absence of a loaded package is determined from the information about a cargo included in the travel record information. The travel time length corresponding to each type of location and presence/absence of a loaded package is acquired on the basis of the timestamp included in the travel record information, for example. The travel distance corresponding to each type of location and presence/absence of a loaded package is acquired on the basis of the position information included in the travel record information, for example.

In the first embodiment, as the analysis result of the travel record information, the travel time length and the travel distance corresponding to the travel location and presence/absence of a cargo assumed by each of types of insurance that can be collectively purchased as one contract are acquired. For example, in the case as illustrated in FIG. 6 where types of insurance assuming combinations of three types of locations and presence/absence of a cargo are set, the travel time length and distance are acquired for six patterns.

The example illustrated in FIG. 7 is an example of the analysis result of the travel record information according to the types of insurance that are set as illustrated in FIG. 6. That is, in FIG. 7, the travel time length and the travel distance are determined for six patterns of (A) a case of traveling on a public road with no package, (B) a case of traveling on a public road with a package, (C) a case of traveling inside the facility A with no package, (D) a case of traveling inside the facility A with a package, (E) a case of traveling inside the building B with no package, and (F) a case of traveling inside the building B with a package. In the following, a calculation process for the insurance premium will be described, taking as an example, the insurance settings in FIG. 6 and the analysis result of the travel record in FIG. 7.

Next, the insurance premium calculation unit 11 determines a weight of each type of insurance. In the first embodiment, the weight of each type of insurance is determined on the basis of the travel distance and time length of the corresponding pattern. Specifically, in the first embodiment, a total value of the travel time length (h) and a value obtained by multiplying the travel distance (Km) by a multiplier α (0<α<1) is taken as the weight of the insurance. That is, in the first embodiment, the travel time length affects the insurance premium more than the travel distance does.

The pattern (A) in FIG. 7 corresponds to a case assumed by the insurance H01. The pattern (B) in FIG. 7 corresponds to a case assumed by the insurance H02. The pattern (C) in FIG. 7 corresponds to a case assumed by the insurance H03. The pattern (D) in FIG. 7 corresponds to a case assumed by the insurance H04. The pattern (E) in FIG. 7 corresponds to a case assumed by the insurance H05. The pattern (F) in FIG. 7 corresponds to a case assumed by the insurance H06. In this case, the weight of each type of insurance is as follows:

Weight W1 of insurance H01: T1+L1×α
Weight W2 of insurance H02: T2+L2×α
Weight W3 of insurance H03: T3+L3×α
Weight W4 of insurance H04: T4+L4×α
Weight W5 of insurance H05: T5+L5×α
Weight W6 of insurance H06: T6+L6×α

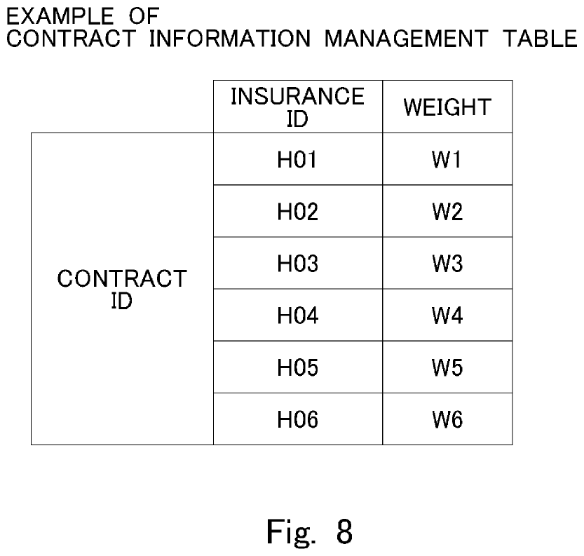

The insurance premium calculation unit 11 stores the calculated weight of each type of insurance in the insurance information DB 14. FIG. 8 is an example of a contract information management table. The contract information management table is a table that is held in the insurance information DB 14 of the insurance management server 1. The contract information management table holds the weight of the insurance of each contract. The weight of the insurance of each contract is re-calculated every predetermined period of time, and the contract information management table is updated every time the weight is re-calculated.

Next, the insurance premium calculation unit 11 acquires a total value of values that are each obtained by multiplying the weight of each type of insurance by the corresponding unit, as the insurance premium of one contract for the vehicle 2. For example, the insurance premium of the contract having the weights as illustrated in FIG. 8 is “insurance premium=W1×50+W2×60+W3×30+W4×40+W5×30+W6×40”.

Additionally, definition of the weight of each type of insurance is not limited to the definition given above. For example, in a case where more emphasis is to be put on the travel distance than on the travel time length, the travel time length may be multiplied by the multiplier α, without multiplying the travel distance by the multiplier α, or the value of the multiplier α may take a value greater than one. Furthermore, for example, the weight of each type of insurance may be determined from only the travel time length or only the travel distance. Moreover, the weight of each type of insurance may be determined on the basis of other elements such as the age of the vehicle and the like, in addition to the travel time length and the travel distance.

<Flow of Processes>

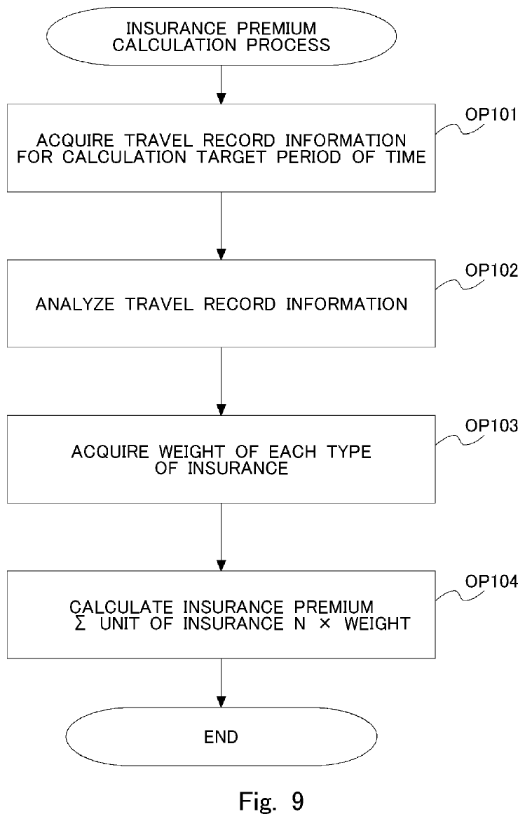

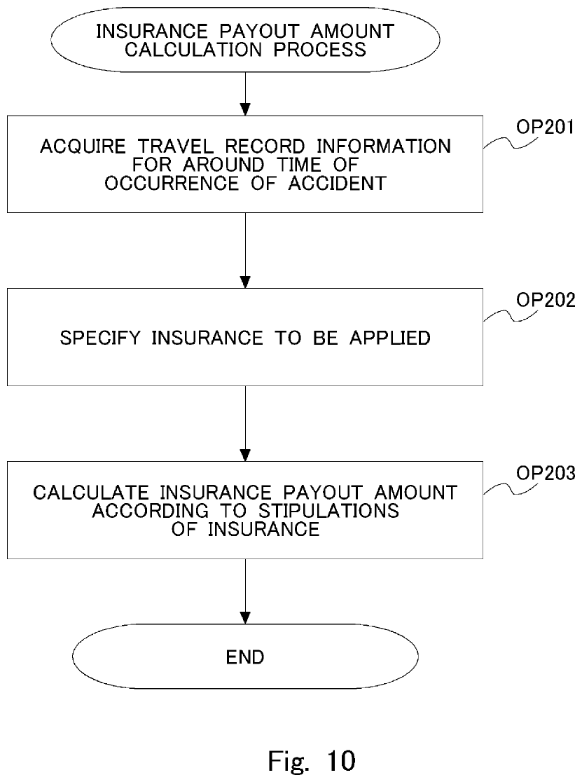

FIG. 9 is an example of a flowchart of the calculation process for the insurance premium. The process illustrated in FIG. 9 is started every predetermined period of time or according to an input of an instruction from an administrator of the insurance management server 1, for example. A performer of the process illustrated in FIG. 9 is the CPU 101 of the insurance management server 1, but a description will be given taking a functional structural element as the performer for the sake of convenience. The same applies to the flowchart in FIG. 10 described later.

In OP101, the insurance premium calculation unit 11 requests the travel record acquisition unit 13 to acquire the travel record information for a period of time that is a calculation target, and acquires the travel record information for the period of time. The travel record acquisition unit 13 issues a request to the delivery management server 3 and acquires the travel record of the target vehicle 2 for the target period of time. In OP102, the insurance premium calculation unit 11 analyzes the travel record information and acquires the travel time length and the travel distance for each of the patterns A to F in FIG. 7, for example.

In OP103, the insurance premium calculation unit 11 acquires the weight of each type of insurance from the analysis result of the travel record information. In OP104, the insurance premium calculation unit 11 calculates the total value of values that are each obtained by multiplying the weight of each type of insurance by the corresponding unit of the type of the insurance, as the insurance premium of one contract for the vehicle 2. Then, the process illustrated in FIG. 9 is ended.

FIG. 10 is an example of a flowchart of a calculation process for the insurance payout amount. For example, the process illustrated in FIG. 10 is started when the administrator of the insurance management server 1 receives a claim for insurance payout from the policyholder and inputs an instruction to the insurance management server 1. A contract ID of an applicant, information about the accident, and the like are also input to the insurance management server 1, for example. Information about the accident includes date/time of occurrence, a location of occurrence, damaged property, a cost of damage, and the like, for example.

In OP201, the insurance payout calculation unit 12 acquires, through the travel record acquisition unit 13, the travel record information on the target vehicle 2 for around the time of occurrence of the accident. For example, the travel record information for ten minutes before and after the occurrence time is acquired. In OP202, the insurance payout calculation unit 12 specifies, from the acquired travel record information, the type of the occurrence location, presence/absence of a cargo, and the like, and specifies the insurance to be applied. For example, in a case where the occurrence location of the accident is inside the building B, and there is a cargo, the insurance H06 is applied.

In OP203, the insurance payout calculation unit 12 calculates the insurance payout amount to be paid, according to the coverage details of the insurance specified in OP202. Then, the process illustrated in FIG. 10 is ended.

### Effects of First Embodiment

In the first embodiment, the insurance premium of one contract collectively including a plurality of types of insurance for the vehicle 2 is calculated according to types of locations where the vehicle 2 travels, including other than public roads, and the travel time lengths and the travel distances. Insurance covering traveling of the vehicle 2 on other than public roads may thus be purchased. Moreover, the insurance premium changes depending on the type of location where the vehicle 2 travels, and the travel time length and the travel distance, and thus, the insurance premium may be based on characteristics of traveling of each vehicle 2.

Furthermore, in the first embodiment, the type of location where the vehicle 2 travels, and the travel time length and the travel distance are acquired from the travel record information on the vehicle 2 for a predetermined period of time. Accordingly, the insurance premium may be based on traveling performance of the vehicle 2, and wasteful payment of the insurance premium may be reduced. Moreover, in the first embodiment, the insurance premium that takes the predetermined period of time as the coverage period is calculated on the basis of the travel record information for the predetermined period of time, and the policyholder is to pay the insurance premium for the past on the basis of past performance. With conventional insurance, the insurance premium is paid with a predetermined period of time in the future as the coverage period, but because the insurance premium is paid with a predetermined period of time in the past as the coverage period, it is not necessary to pay for unnecessary compensation, and wasteful payment of insurance premium may be reduced.

Moreover, in the first embodiment, in a case where there is occurrence of an accident involving the vehicle 2 and there is a claim for insurance payout, the insurance to be applied is specified according to the occurrence location of the accident, presence/absence of a cargo, and the like, and the insurance payout amount is calculated within a range of the coverage details of the insurance that is applied. Accordingly, an appropriate insurance payout amount according to the situation may be paid.

### Second Embodiment

In the first embodiment, a plurality of types of insurance that can be collectively purchased as one contract are types of insurance corresponding to each combination of the type of location where the vehicle 2 travels and the state of presence/absence of a cargo. In a second embodiment, a plurality of types of insurance that can be collectively purchased as one contract are prepared instead for each object of coverage. Specifically, in the second embodiment, automobile physical damage insurance that takes the vehicle 2 itself as the object of coverage, cargo insurance that takes a cargo on the vehicle 2 as the object of coverage, third-party property insurance that takes an object that the vehicle 2 damaged as the object of coverage, third-party injury insurance that takes injury to a person by the vehicle 2 as the object of coverage, and the like are prepared, and these are combined as one contract. Additionally, a description of the second embodiment overlapping that of the first embodiment will be omitted.

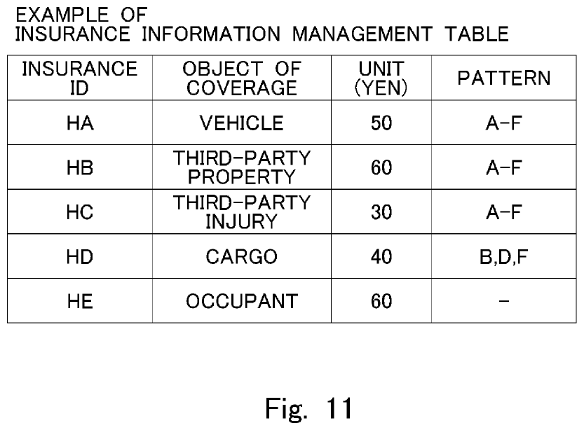

FIG. 11 is an example of an insurance information management table according to the second embodiment. The insurance information management table illustrated in FIG. 11 includes items of “insurance ID”, “object of coverage”, “unit”, and “pattern”. Identification information on insurance is stored under the item “insurance ID”. Information indicating the object of coverage of the insurance is stored under the item “object of coverage”.

Information indicating the object of coverage of insurance indicates a vehicle, third-party property, a third-party injury, a cargo, an occupant, or the like, for example. Insurance HA that takes a vehicle as the object of coverage is insurance that takes the vehicle 2 itself as the object of coverage. Insurance HB that takes third-party property as the object of coverage is insurance that covers an object that is damaged by the vehicle 2. Insurance HC that takes a third-party injury as the object of coverage is insurance that takes a person who is injured by the vehicle 2 as the object of coverage. Insurance HD that takes a cargo as the object of coverage is insurance that takes a cargo on the vehicle 2 as the object of coverage. Insurance HE that takes an occupant as the object of coverage is insurance that takes an occupant on board the vehicle 2 as the object of coverage. Additionally, in the second embodiment, types of insurance for the vehicle 2 are not limited to those illustrated in FIG. 11.

A sum that is a unit for calculating the insurance premium is stored under the item “unit”. Information indicating a pattern based on analysis of the travel record information to which the insurance is to be applied is stored under the item “pattern”. In the example illustrated in FIG. 11, pieces of identification information on patterns based on the analysis result of the travel record information illustrated in FIG. 7 are stored under the item “pattern”.

The insurance HA is insurance that takes the vehicle 2 itself as the object of coverage and is thus applied to all of the patterns (A) to (F). The insurance HB is third-party property insurance and is thus applied to all of the patterns (A) to (F). The insurance HC is third-party injury insurance and is thus applied to all of the patterns (A) to (F). The insurance HD is insurance that covers cargoes and is thus applied to the patterns (B), (D) and (F) that include a state where a cargo is present. The insurance HE is insurance that takes an occupant as the object of coverage, and is not applied to any of the patterns, because the vehicle 2 in the second embodiment is not expected to carry a person.

In the second embodiment, the insurance premium calculation unit 11 determines, as the weight of insurance, for each pattern to which the insurance is to be applied, a total value of values that are each obtained by multiplying a coefficient corresponding to a travel location by the travel distance and the travel time length. Specifically, in a case where types of insurance as illustrated in FIG. 11 are prepared and an analysis result of the travel record information as illustrated in FIG. 7 is obtained, the weight of each type of insurance is determined in the following manner, for example. The coefficient corresponding to the type of travel location is, for example, β for public roads, and γ for other than public roads, where the facility A and the building B are given as other than public roads. For example, 0<γ<β is true. Additionally, the coefficient may alternatively be set for each facility and each building.

Weight WA of insurance HA: β{(T1+αL1)+(T2+αL2)}+γ{(T3+αL3)+(T4+αL4)+(T5+αL5)+(T6+αL6)}

Weight WB of insurance HB: same as WA

Weight WC of insurance HC: same as WA

Weight WD of insurance HD: β(T1+αL1)+γ{(T4+αL4)+(T6+αL6)}

Weight WE of insurance HE: 0

The calculation method for the insurance premium is the same as that in the first embodiment, and the insurance premium for one contract is a total value of values that are each obtained by multiplying the weight and the unit of respective type of insurance. Furthermore, regarding the calculation method of the insurance payout amount, for example, insurance that is to be applied is specified on the basis of the occurrence location of the accident and damaged property, and the insurance payout amount according to the stipulations of the insurance that is specified is calculated. For example, in a case where the occurrence location of the accident is in the building B, and the vehicle 2, the cargo, and equipment in the building B are damaged, the insurance HA, the insurance HB, and the insurance HD are specified, and an insurance payout amount is paid according to the stipulations of each type of insurance.

### Effects of Second Embodiment

In the second embodiment, types of insurance for respective objects of coverage are prepared as insurance that can be collectively purchased as one contract, and thus, such contract is simpler and more easily understood by a person purchasing insurance. Moreover, insurance may be flexibly prepared according to the travel location of the vehicle 2 or a boarding state of an occupant or a cargo.

### Other Embodiments

The embodiments described above are merely examples, and modifications may be made as appropriate within the scope of the present disclosure.

In the first and second embodiments, information indicating what kind of location the vehicle 2 traveled and to what extent is acquired from the travel record information on the vehicle 2 for a predetermined period of time, but such a case is not restrictive. For example, a predicted value indicating what kind of location the vehicle 2 will travel and to what extent may be used depending on the type, intended use and the like of the vehicle 2. A learned model may be used to predict what kind of location the vehicle 2 will travel and to what extent, for example.

Furthermore, in the first and second embodiments, the travel record information is transmitted to the delivery management server 3 every time the travel record information is created by the vehicle 2, and is held in the delivery management server 3, but such a case is not restrictive. For example, the vehicle 2 may create the travel record information, and hold the travel record information without transmitting the same to the delivery management server 3. The travel record information may be acquired from the vehicle 2 through the delivery management server 3 when there is an acquisition request for the travel record information on the vehicle 2.

Processes and means described in the present disclosure may be freely combined and implemented to the extent that no technical conflicts exist.

Furthermore, a process that is described to be performed by one device may be shared and performed by a plurality of devices. Furthermore, processes described to be performed by different devices may be performed by one device. Which function is to be implemented by which hardware configuration (server configuration) in a computer system may be flexibly changed.

The present disclosure may also be implemented by supplying computer programs for implementing the functions described in the embodiments described above to a computer, and by one or more processors of the computer reading out and executing the programs. Such computer programs may be provided to the computer by a non-transitory computer-readable storage medium that can be connected to a system bus of the computer or may be provided to the computer through a network. The non-transitory computer-readable storage medium may be, for example, any type of disk including magnetic disks (floppy (registered trademark) disks, hard disk drives (HDDs), etc.) and optical disks (CD-ROMs, DVD discs, Blu-ray discs, etc.), read-only memories (ROMs), random access memories (RAMs), EPROMs, EEPROMs, magnetic cards, flash memories, optical cards, and any type of medium suitable for storing electronic instructions.

What is claimed is:

1. An information processing apparatus comprising a control unit configured to calculate an insurance premium of insurance for a vehicle, based on at least a time length of travel of the vehicle on a public road and a time length of travel of the vehicle on other than the public road, or a travel distance of the vehicle on the public road and a travel distance of the vehicle on other than the public road.

2. The information processing apparatus according to claim 1, wherein the control unit is configured
to determine a weight of each of a plurality of types of insurance with different coverage details, based on at least the time length of travel of the vehicle on the public road and the time length of travel of the vehicle on other than the public road, or the travel distance of the vehicle on the public road and the travel distance of the vehicle on other than the public road, and
to calculate an insurance premium of one contract for the vehicle, based on the weight.

3. The information processing apparatus according to claim 2, wherein the control unit is configured
to determine the weight of each of the plurality of types of insurance, based on at least the time length of travel of the vehicle on the public road and a time length of travel of the vehicle in a location corresponding to each of a plurality of types of locations as locations other than the public road, the plurality of types of locations including inside a building, or the travel distance of the vehicle on the public road and a travel distance of the vehicle in the location corresponding to each of the plurality of types of locations, and
to calculate the insurance premium of one contract for the vehicle, based on the weight of each of the plurality of types of insurance.

4. The information processing apparatus according to claim 2, wherein the control unit is configured to determine the weight of each of the plurality of types of insurance, based further on a time length of each of a plurality of loading states of the vehicle, the plurality of loading states including a state where an occupant or a cargo is on board and a state where an occupant or a cargo is not on board.

5. The information processing apparatus according to claim 2, wherein the control unit is configured to calculate, as the insurance premium for the vehicle, a total value obtained by multiplying a basic insurance premium of each of the plurality of types of insurance by a corresponding weight.

6. The information processing apparatus according to claim 2, wherein
the control unit is configured to acquire, from travel record information for a predetermined period of time in immediate past, at least the time length of travel of the vehicle on the public road and the time length of travel of the vehicle on other than the public road, or the travel distance of the vehicle on the public road and the travel distance of the vehicle on other than the public road, and
the predetermined period of time is taken as a coverage period of the insurance premium that is calculated.

7. The information processing apparatus according to claim 2, wherein the control unit is further configured
to specify, in a case where there is occurrence of an accident involving the vehicle, according to a location of occurrence of the accident, insurance that is to be applied from among the plurality of types of insurance, and
to calculate an insurance payout amount to be paid to compensate for a damage caused by the accident, according to the insurance that is specified.

8. The information processing apparatus according to claim 7, wherein the control unit is configured to specify the insurance that is to be applied, based further on a loading state of the vehicle at a time of occurrence of the accident.

9. The information processing apparatus according to claim 2, wherein the plurality of types of insurance include types of insurance corresponding to different types of locations among a plurality of types of locations at least including the public road and a location other than the public road.

10. The information processing apparatus according to claim 2, wherein the plurality of types of insurance include types of insurance corresponding to different objects of coverage among a plurality of objects of coverage.

11. An information processing method performed by a computer, the computer configured to calculate an insurance premium of insurance for a vehicle, based on at least a time length of travel of the vehicle on a public road and a time length of travel of the vehicle on other than the public road, or a travel distance of the vehicle on the public road and a travel distance of the vehicle on other than the public road.

12. The information processing method according to claim 11, wherein the computer is configured
to determine a weight of each of a plurality of types of insurance with different coverage details, based on at least the time length of travel of the vehicle on the public road and the time length of travel of the vehicle on other than the public road, or the travel distance of the vehicle on the public road and the travel distance of the vehicle on other than the public road, and
to calculate an insurance premium of one contract for the vehicle, based on the weight.

13. The information processing method according to claim 12, wherein the computer is configured
to determine the weight of each of the plurality of types of insurance, based on at least the time length of travel of the vehicle on the public road and a time length of travel of the vehicle in a location corresponding to each of a plurality of types of locations as locations other than the public road, the plurality of types of locations including inside a building, or the travel distance of the vehicle on the public road and a travel distance of the vehicle in the location corresponding to each of the plurality of types of locations, and
to calculate the insurance premium of one contract for the vehicle, based on the weight of each of the plurality of types of insurance.

14. The information processing method according to claim 12, wherein the computer is configured to determine the weight of each of the plurality of types of insurance, based further on a time length of each of a plurality of loading states of the vehicle, the plurality of loading states including a state where an occupant or a cargo is on board and a state where an occupant or a cargo is not on board.

15. The information processing method according to claim 12, wherein the computer is configured to calculate, as the insurance premium for the vehicle, a total value obtained by multiplying a basic insurance premium of each of the plurality of types of insurance by a corresponding weight.

16. The information processing method according to claim 12, wherein
the computer is configured to acquire, from travel record information for a predetermined period of time in immediate past, at least the time length of travel of the vehicle on the public road and the time length of travel of the vehicle on other than the public road, or the travel distance of the vehicle on the public road and the travel distance of the vehicle on other than the public road, and
the predetermined period of time is taken as a coverage period of the insurance premium that is calculated.

17. The information processing method according to claim 12, wherein the computer is configured
to specify, in a case where there is occurrence of an accident involving the vehicle, according to a location of occurrence of the accident, insurance that is to be applied from among the plurality of types of insurance, and
to calculate an insurance payout amount to be paid to compensate for a damage caused by the accident, according to the insurance that is specified.

18. The information processing method according to claim 17, wherein the computer is configured to specify the insurance that is to be applied, based further on a loading state of the vehicle at a time of occurrence of the accident.

19. A non-transitory storage medium storing a program for causing a computer to calculate an insurance premium of insurance for a vehicle, based on at least a time length of travel of the vehicle on a public road and a time length of travel of the vehicle on other than the public road, or a travel distance of the vehicle on the public road and a travel distance of the vehicle on other than the public road.

20. The non-transitory storage medium storing the program according to claim 19, wherein the program causes the computer to
determine a weight of each of a plurality of types of insurance with different coverage details, based on at least the time length of travel of the vehicle on the public road and the time length of travel of the vehicle on other than the public road, or the travel distance of the vehicle on the public road and the travel distance of the vehicle on other than the public road, and
calculate an insurance premium of one contract for the vehicle, based on the weight.
